(19) United States
(12) Patent Application Publication
(10) Pub. No.: US 2025/0382808 A1
(43) Pub. Date: Dec. 18, 2025

(54) A Floor Removal Tool and Uses and Methods Thereof

(71) Applicants: Ivan Yazmani Aleman Cabrera, Ottawa, ON (CA); Pamela Desangles Benimeli, Ottawa, ON (CA)

(72) Inventors: Ivan Yazmani Aleman Cabrera, Ottawa, ON (CA); Pamela Desangles Benimeli, Ottawa, ON (CA)

(21) Appl. No.: 18/878,167

(22) PCT Filed: Jun. 22, 2023
(86) PCT No.: PCT/CA2023/050870

§ 371 Date: Dec. 23, 2024

Related U.S. Application Data
(60) Provisional application No. 63/355,028, filed on Jun. 23, 2022.

(51) Int. Cl. E04G 23/00; B25C 11/00; B66F 15/00

(52) U.S. Cl. CPC E04G 23/006; B25C 11/00; B66F 15/00

(57) ABSTRACT

A floor removal tool comprising a beveled, thin base connected to a long handle, which is used for the removal of materials adhered to a surface, commonly flooring or subflooring. The beveled base is wide to facilitate the efficient removal of large amounts of material when the ergonomic handle is pushed or pulled to leverage the adhered material up. The beveled base is also connected to a second vertical plate that has a fulcrum sill. When a suitably sized block is placed under the sill, the pivot point is raised such that there is a decreased chance of damaging the surface. The base can be easily struck by a man-powered tool or it can be connected to an air-powered tool to facilitate tool insertion under the material to be removed.

### FIELD OF INVENTION

This invention relates to a floor removal tool, and, in particular, a floor removal tool which can be manually or mechanically used to more easily and efficiently separate flooring or subflooring from its adhered to surface.

### BACKGROUND OF THE INVENTION

The present invention relates to a floor removal tool and the uses and methods thereof. Currently, there is a need in the art for a tool that can facilitate a more efficient and less painstaking method of removing flooring and subflooring. At present, the removal of flooring involves someone placing a crowbar or chisel adjacent to the substance to be removed and forcefully contacting the tool with a hammer to chip or pry away small portions of the flooring or substructure or both. This is a very inefficient process which removes only small portions of flooring with each attempt. Moreover, striking the crowbar/chisel with a hammer is highly inefficient even for the skilled worker, simply because the contact surface on the prying tool is quite small. The current method also requires the user to bend constantly or kneel, increasing the likelihood of work-related back pain or other injuries.

### SUMMARY OF THE INVENTION

The present invention relates to a tool for the removal of material, such as flooring, subflooring, or hard walls adhered to a surface.

According to the present invention there is provided a floor removal tool comprising a base member, which comprises a thin plate member. The thin plate member comprising a bevel or wedge at a first proximal side, the opposite distal side of the thin plate member mating with or integrally attached to a second plate or rectangular member extending transversely upward therefrom. The floor removal tool further comprises a bracing member, which forms an integral attachment with both the thin plate member at or near the distal side and the second plate member, at the point, upward from the point, or both at the point and upward from the point at which the thin plate member and second plate member intersect, and centered in respect thereof.

The bracing member forms a solid or hollow member or tube, which comprises an aperture on the reverse side of the second plate member. The aperture is for optionally receiving a tool engaging member, with the tool engaging member engaging a surface inside, around or both inside and around the aperture on the reverse of the second plate member. The floor removal tool further comprises a handle attachment member attached or integral with the bracing member and extending therefrom, with the handle attachment member adapted to receive a handle or a second tool member.

In a further embodiment, there is provided the above floor removal tool wherein the floor removal tool further comprises a bend, lip, ledge, or fulcrum sill that extends about perpendicularly from the second plate member opposite the side contacting the thin plate member.

In a further embodiment, there is provided the above floor removal tool wherein the aperture on the reverse side of the second plate member receives a tool engaging member, a chisel, or a pneumatic tool.

In a further embodiment, there is provided the above floor removal tool wherein the aperture is surrounded by a mating assembly for receiving a tool engaging member, a chisel, or a pneumatic tool.

In a further embodiment, there is provided the above floor removal tool wherein the thin plate member comprises a u shaped structure or comprises a plurality of bevels or wedges at the proximal side.

In a further embodiment, there is provided the above floor removal tool wherein the plurality of bevels or wedges at the proximal side of the thin plate member are separated by one or more slots.

In a further embodiment, there is provided the above floor removal tool wherein the bevels or wedges are tapered along about a quarter or more of the length of the first plate member.

In a further embodiment, there is provided the above floor removal tool wherein the tool is made of high carbon steel.

In a further embodiment, there is provided the above floor removal tool wherein the tool is made of high carbon steel and the handle is made of hollow aerospace aluminum.

In a further embodiment, there is provided the above floor removal tool wherein the second plate comprises a plurality of hook apertures or attachments which facilitate application of upward force of the first plate member generally perpendicular to the plane thereof. In a further embodiment of the present invention, there is provided the above floor removal tool wherein the fulcrum sill comprises a plurality of apertures that facilitate the application of an upward force of the first plate member generally perpendicular to the plane thereof.

In a further embodiment, there is provided the above floor removal tool wherein the handle engages the handle attachment member via spring-loaded members, one or more quick release pins, or is threadedly engaged via screw threads.

In a further embodiment, there is provided the above floor removal tool wherein the back of the second plate is substantially flat.

In a further embodiment, there is provided the above floor removal tool wherein the fulcrum sill prevents rotational or pivotal movement of the floor removal tool about the axis where the thin plate and second plate connect, when a suitably sized block or the like is placed under the sill. The fulcrum sill raises the contact point around which the floor removal tool pivots so as to prevent damage to the subfloor or surface.

In a further embodiment, there is provided the above floor removal tool wherein the handle comprises a crow bar, nail removal tool, or a combination thereof.

In a further embodiment, there is provided the above floor removal tool wherein the angle formed by the plane of the first plate member and the handle is less than about 90 degrees.

In a further embodiment, there is provided the above floor removal tool wherein the angle formed by the plane of the first plate member and the handle is about 85 degrees.

In a further embodiment, there is provided the above floor removal tool wherein the handle facilitates rotational or pivotal movement of the thin plate member along its axis at the distal portion thereof where it connects with the second plate extending transversely therefrom.

In a further embodiment, there is provided the above floor removal tool, wherein the nail remover tool comprises a lever, which is angled approximately 46° from the handle member. The lever comprises a bevel or wedge, a fissure in the center of the lever, and a rounded member or fulcrum. The rounded fulcrum comprises an aperture on the side opposite the lever for optionally receiving a tool engaging member, which may engage a surface inside, around, or both inside and around the aperture in the rounded fulcrum.

In a further embodiment, there is provided the above floor removal tool, wherein the nail remover tool comprises a lever, which is angled approximately 46° from the handle member. The lever comprises a bevel or wedge, a fissure in the center of the bevel or wedge, a fulcrum heel angled at 15° from the handle member, hook brackets that are an extension from the fulcrum heel and protrude beyond a third plate member, wherein the third plate member connects the fulcrum heel to the bevel or wedge opposite the fissure. The third plate member comprises an aperture for optionally receiving a tool engaging member, which may engage a surface inside, around, or both inside and around the aperture in the third plate member.

In a further embodiment, there is provided a use of the above floor removal tool to remove a substance adhered to a surface.

In a further embodiment, there is provided a use of the above nail removal tool to remove a substance adhered to a surface.

In a further embodiment, there is provided the use of the above floor removal tool or nail removal tool in removing flooring adhered to a surface.

In a further embodiment, there is provided the use of the above floor removal tool or nail removal tool in removing subflooring adhered to a surface.

In a further embodiment, there is provided a method of removing material from a surface using the above floor removal tool comprising: (1) placing the above floor removal tool adjacent to the material to be removed, (2) striking the second plate member with a man-powered tool to facilitate insertion of the floor removal tool under the material, and (3) pulling the handle in a direction that leverages the material away from the surface.

In a further embodiment, there is provided the above method wherein the man-powered tool is a hammer or sledgehammer.

In a further embodiment, there is provided a method of removing a material from a surface, comprising: (1) positioning the above floor removal tool adjacent to the material to be removed, (2) engaging the tool engaging member of the flooring removal tool with a pneumatic tool, (3) activating the pneumatic tool to insert the floor removal tool under the material, and (4) pulling the handle in a direction that leverages the material away from the surface.

In a further embodiment, there is provided the above method for removing material adhered to a surface wherein the pneumatic tool is a jackhammer.

In a further embodiment, there is provided a method of removing a material from a surface, comprising: (1) detaching the handle from the above floor removal tool, (2) positioning the above nail removal tool under the material to be removed, and (3) pushing or pulling the handle in a direction that leverages the material away from the surface.

In a further embodiment, there is provided a method of removing a material from a surface, comprising: (1) detaching the handle from the above floor removal tool, (2) positioning the above nail removal tool adjacent to the material to be removed, (3) engaging the tool engaging member of the nail removal tool with a pneumatic tool, (4) activating the pneumatic tool to insert the nail removal tool under the material, and (5) pushing or pulling the handle in a direction that leverages the material away from the surface.

In a further embodiment, there is provided a method of removing material from a surface using the above floor removal tool comprising: (1) detaching the handle from the above floor removal tool, (2) positioning the above nail removal tool adjacent to the material to be removed, (3) striking the third plate member with a man-powered tool to facilitate insertion of the nail removal tool under the material, and (4) pushing or pulling the handle in a direction that leverages the material away from the surface.

In a further embodiment, there is provided the above method wherein the pneumatic tool is a jackhammer.

In a further embodiment, there is provided a method of removing a material from a surface, comprising: (1) positioning the above floor removal tool adjacent to the material to be removed, (2) striking the second plate member with a man-powered tool to facilitate insertion of the floor removal tool under the material, (3) attaching a hook or jack to the plurality of hook apertures, and (4) mechanically lifting the floor removal tool up to remove the material.

In a further embodiment, there is provided a method of removing a material from a surface, comprising: (1) positioning the above floor removal tool adjacent to the material to be removed, (2) striking the second plate member with a man-powered tool to facilitate insertion of the floor removal tool under the material, (3) attaching a hook or jack to the plurality of fulcrum sill apertures, and (4) mechanically lifting the floor removal tool up to remove the material.

In a further embodiment, there is provided the above floor removal tool wherein the plurality of bevels or wedges are spaced to fit around building materials.

In a further embodiment, there is provided the above floor removal tool wherein the building materials are wooden beams, metal beams, stone beams, plastic piping, or metal piping.

In a further embodiment, there is provided the above floor removal tool wherein the building materials are 2 inches×4 inches, 4 inches×4 inches, or 4 inches in diameter or less.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows the floor removal tool (10) comprising a base member (20), which comprises a thin plate member (30), two bevels or wedges (40), a proximal side (50), a distal side (60), a second plate member (70), a bracing member (80), a handle attachment member (100), a fulcrum sill (120), a slot (130), and hook apertures (140). The floor removal tool (10) further comprises a handle (110) with a nail removal tool (7) distal to the base member (20), comprising a lever (150) and rounded fulcrum (180).

FIG. 2 shows a font view of the base member (20) of the floor removal tool (10) comprising a thin plate member (30), two bevels or wedges (40), a proximal side (50), a distal side (60), a second plate member (70), a bracing member (80), a handle attachment member (100), a fulcrum sill (120), a slot (130), and hook apertures (140). The figure depicts the handle attachment member (100) being attached to a handle (110).

FIG. 3 shows a rear view of the base member (20) of the floor removal tool (10) comprising a thin plate member (30), two bevels or wedges (40), a proximal side (50), a distal side (60), a second plate member (70), a hollow member or tube comprising an aperture (90), a handle attachment member (100), a fulcrum sill (120), a slot (130), and hook apertures (140). The figure depicts the handle attachment member (100) being attached to a handle (110). Additionally, the fulcrum sill is circled and labelled “3.”.

FIG. 4 shows a side view of the nail removal tool (7) comprising a lever (150), a bevel or wedge (160), a fissure (170), and rounded fulcrum (180), attached to a handle (110).

FIG. 5 shows a rear view of the nail removal tool (7) comprising a lever (150), a bevel or wedge (160), a fissure (170), a rounded fulcrum (180), and an aperture (190) for engaging a tool engaging member. The nail removal tool is attached to a handle (110). The rounded fulcrum is emphasized by being circled and labelled as “8.”.

FIG. 6 shows a rear view of the base member (20) of the floor removal tool (10) comprising a thin plate member (30), two bevels or wedges (40), a proximal side (50), a distal side (60), a second plate member (70), a hollow member or tube comprising an aperture (90), a handle attachment member (100), a fulcrum sill (120), a slot (130), and fulcrum sill apertures (200). The figure depicts the handle attachment member (100) being attached to a handle (110). FIG. 7 shows another rear view of the base member (20) of the floor removal tool (10) comprising a thin plate member (30), two bevels or wedges (40), a proximal side (50), a distal side (60), a second plate member (70), a hollow member or tube comprising an aperture (90), a handle attachment member (100), a fulcrum sill (120), a slot (130), and fulcrum sill apertures (200). The figure depicts the handle attachment member (100) being attached to a handle (110).

FIG. 8 shows a side view of the nail removal tool (7) comprising a lever (150), wherein the lever comprises a bevel or wedge (160), a fissure (170), a fulcrum heel (210), a third plate member (220), hook brackets (240), and an aperture (190), attached to a handle (110).

FIG. 9 shows the floor removal tool (10) comprising a base member (20), which comprises a thin plate member (30), two bevels or wedges (40), a proximal side (50), a distal side (60), a second plate member (70), a handle attachment member (100), a fulcrum sill (120), a slot (130), and fulcrum sill apertures (200). The floor removal tool (10) further comprises a handle (110) with a nail removal tool (7) distal to the base member (20), comprising a lever (150), fulcrum heel (210), and a third plate member (220).

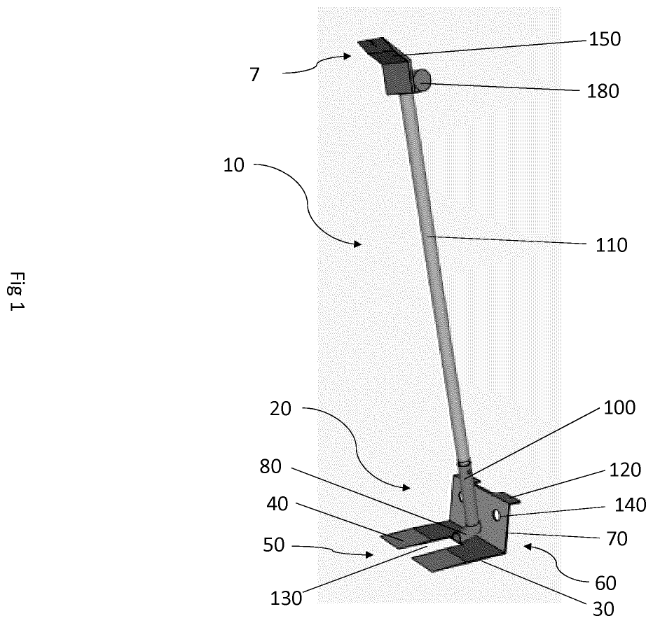

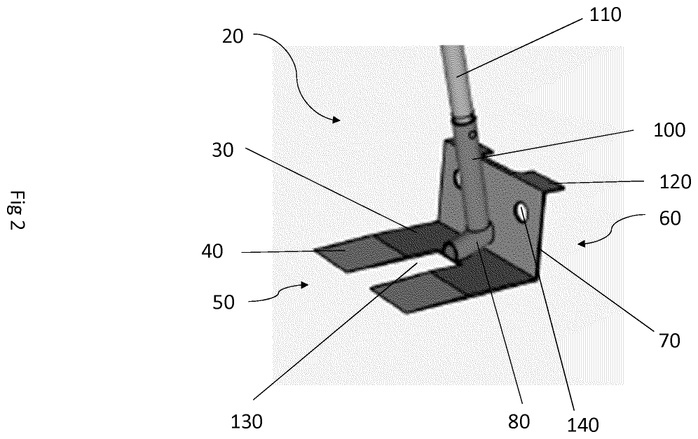

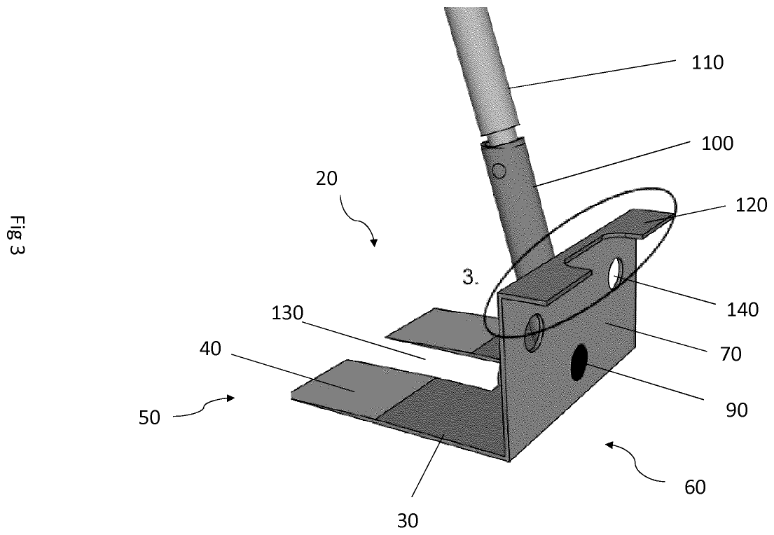

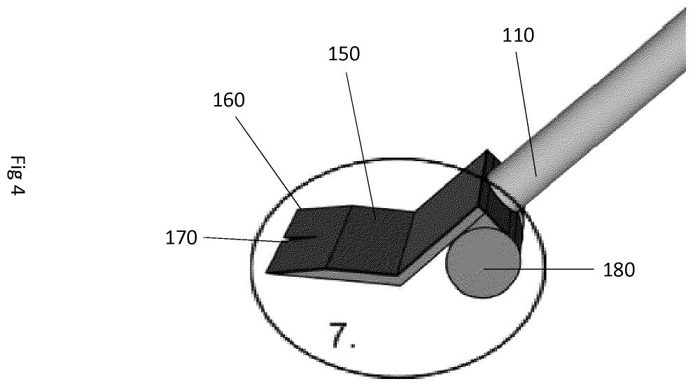

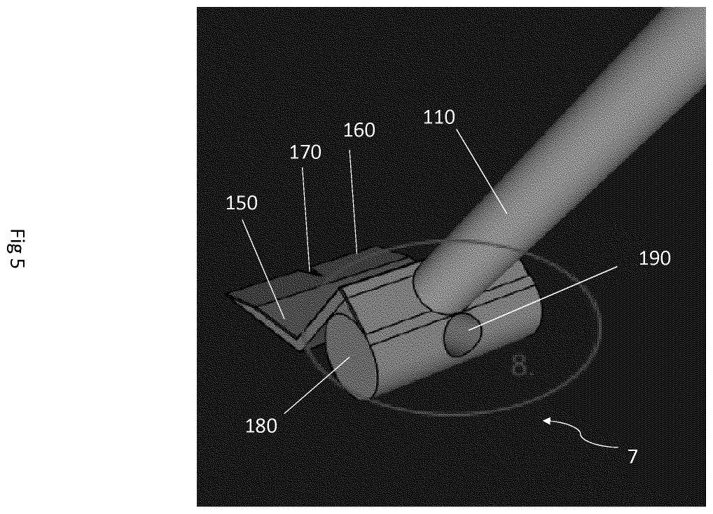

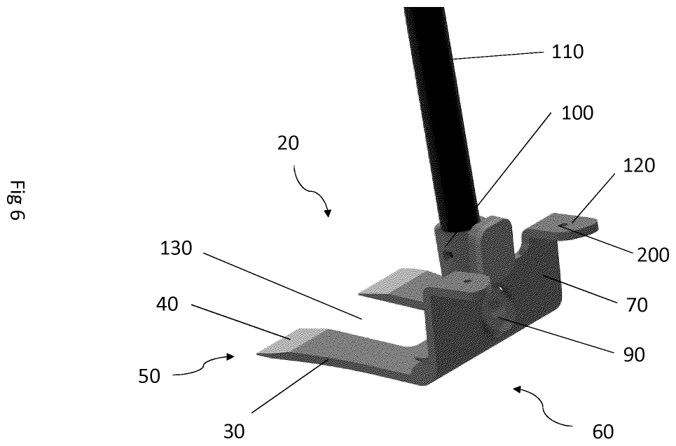

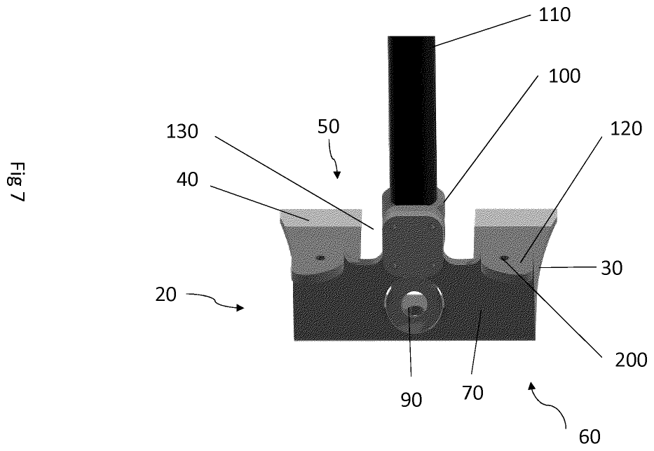

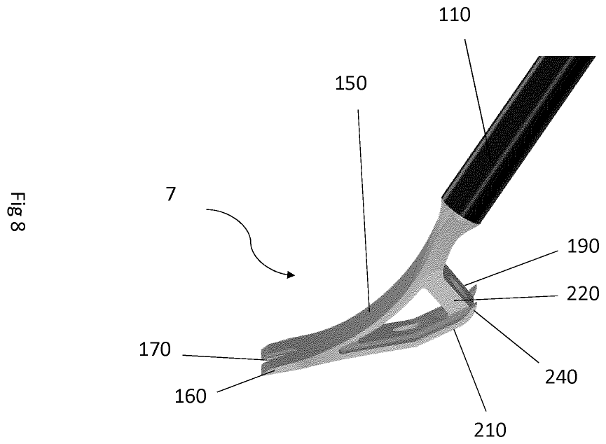

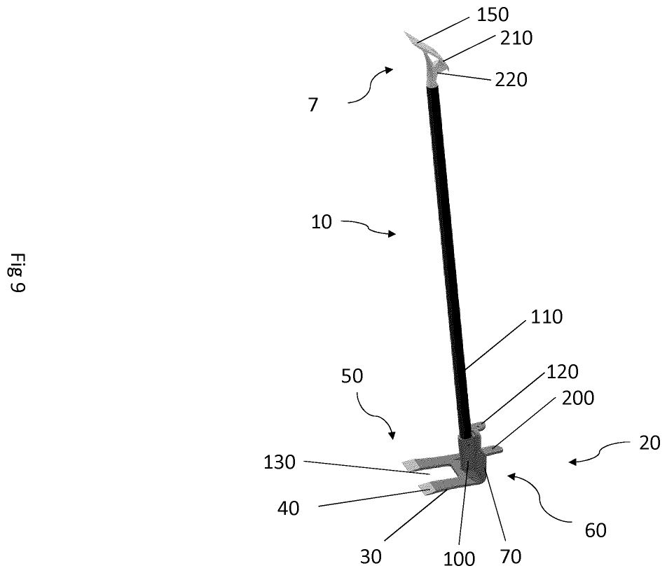

### DETAILED DESCRIPTION

In an embodiment of the present invention, there is provided a floor removal tool that comprises,
a base member (20) comprising a thin plate member (30), the thin plate member comprising a bevel or wedge (40) at a first proximal side (50), the opposite distal side (60) of the thin plate member mating with or integrally attached to a second plate or rectangular member (70) extending transversely upward therefrom,
a bracing member (80), the bracing member forming an integral attachment with both the thin plate member (30) at or near the distal side and the second plate (70), at the point, upward from the point, or both at the point and upward from the point at which the thin plate member and second plate member intersect, and centered in respect thereof, the bracing member (80) forming a solid or hollow member or tube, the hollow member or tube comprising an aperture (90) on the reverse side of the second plate member, the aperture for optionally receiving a tool engaging member, the tool engaging member engaging a surface inside, around or both inside and around the aperture on the reverse of the second plate member;
a handle attachment member (100) attached or integral with the bracing member (80) and extending therefrom, the handle attachment member adapted to receive a handle (110) or a second tool member.

The present embodiment describes a floor removal tool, however it is contemplated that this tool may be used, without being limiting, to remove materials from walls or ceilings. This may include, but is not limited to, wall tiles, drywall, plaster walls, plaster walls with wire mesh, and ceiling tiles. In another embodiment the thin plate member of the floor removal tool can be, but is not limited to, a square or rectangular shape. It is also contemplated that the thin plate member is not limited to a particular thickness and can be the thickness needed for insertion under an adhered material and for withstanding the leveraging forces required to remove such material. In another contemplated embodiment, the second plate member may be perpendicular to the thin plate member or may be angled so as to allow a striking force to be applied to the second plate member. In an embodiment of the present invention, the second plate member extends vertically to a degree such that a device or tool used to apply force to the floor removal tool can contact the surface without a significant degree of difficulty by someone skilled in the art. It is also contemplated that the second plate member may be rectangular or any other shape. It is further contemplated that the thin plate member and the second plate member may be of sufficient thickness such that the bracing member is not necessary for withstanding and transferring the force applied to the second plate member to the thin plate member. Another embodiment of the floor removal tool includes more than one bracing member spaced variably along the joint between the thin plate member and second plate member. Moreover, it is contemplated that the handle attachment member may be attached or integral with the thin plate member or the second plate member. The handle attachment member may extend perpendicular to the thin plate member or may be angled therefrom. In another embodiment, the handle attached to the handle attachment member may be, but is not limited to, a curved or linear pole, the length of which may vary. In another embodiment, there may be a plurality of holes in the base member to facilitate hanging of the floor removal tool when not in use.

In another embodiment of the above floor removal tool, the floor removal tool may further comprise a bend, lip, ledge or fulcrum sill (120) that extends about perpendicularly from the second plate member opposite the side contacting the thin plate member. The fulcrum sill (120) is of a sufficient depth to facilitate the placement of a solid material, such as, but not limited to, a wood block.

In a further embodiment of the above floor removal tool, there is provided the floor removal tool wherein the aperture (90) of on the reverse side of the second plate member receives a tool engaging member, a chisel or pneumatic tool. It is contemplated that the tool engaging member encompass any structure that allows the attachment of an extrinsic device or tool that would facilitate the desired function of the floor removal tool. In another embodiment, the pneumatic tool may be, but is not limited to, a jackhammer, an air hammer, a chipping hammer, or other air-powered device capable of facilitating the function of the floor removal tool.

In yet another embodiment, there is provided the above floor removal tool wherein the aperture is surrounded by a mating assembly for receiving a tool engaging member, a chisel or pneumatic tool. The mating assembly is contemplated to be a structure that is capable of attaching an extrinsic device or tool to facilitate the function of the floor removal tool.

In a further embodiment, there is provided the above floor removal tool wherein the thin plate member may comprise a u shaped structure or may comprise a plurality of bevels or wedges at the proximal side. The u shaped structure may comprise wide prongs that extend from the distal to the proximal side of the floor removal tool, separated by a gap of constant or variable width. It is contemplated that the number of prongs is not limited to two but may comprise a plurality of prongs. Moreover, the u shaped structure may not be restricted to a u shape, but may be variably shaped so as to allow for the floor removal tool to fit around various sized impediments or structures.

In another embodiment, there is provided the above floor removal tool wherein the plurality of bevels or wedges at the proximal side of the thin plate member are separated by one or more slots (130). These slots may be of variable size and depth to facilitate the positioning of the floor removal tool around impediments or structures.

In a further embodiment, there is provided the above floor removal tool wherein the bevels or wedges are tapered along about a quarter or more of the length of the thin plate member. Without wishing to be limiting in any manner, it is contemplated that the tapering of the thin plate member may begin less than a quarter of the way along the length of the thin plate member or may be absent altogether.

In yet another embodiment, there is provided the above floor removal tool wherein the tool is made of steel, for example, but not limited to high carbon steel. However, the floor removal tool or any part thereof may be made from a different durable substance such as, but not limited to, other steel alloys or aerospace aluminum as would be understood by a person of skill in the art. A particular embodiment of this invention has the base member (20) and the nail removal tool (7) being made of high carbon steel and the handle being made of hollow aerospace aluminum. Further, another embodiment of the present invention may comprise a hard rubber, impact-resistant backing for the second plate member to minimize sound irritation when the user strikes the second plate member with another tool or device. It is envisioned that this backing may not be limited to hard rubber, but may include any impact-resistant material.

In a further embodiment, there is provided the above floor removal tool wherein the second plate comprises a plurality of hook apertures (140) or attachments which facilitate application of an upward force on the first plate member generally perpendicular to the plane thereof. These apertures or attachments may be variably spaced on the second plate member and the upward force may be applied by, but not limited to, a jack, floor crane, hooks, wires, ropes, or hoist. It is also contemplated that the force may not be applied in a perpendicular direction, but may be applied at an angle to assist in the function of the floor removal tool. In a further embodiment, there is provided the above floor removal tool wherein the fulcrum sill comprises a plurality of apertures (200) which facilitate application of an upward force on the first plate member generally perpendicular to the plane thereof. These apertures may be variably spaced on the fulcrum sill and the upward force may be applied by, but not limited to, a jack, floor crane, hooks, wires, ropes, or hoist. It is also contemplated that the force may not be applied in a perpendicular direction, but may be applied at an angle to assist in the function of the floor removal tool.

In yet another embodiment, there is provided the above floor removal tool wherein the handle engages the handle attachment member via spring-loaded members, one or more quick release pins, or is threadedly engaged via screw threads. It is also envisioned that the handle and handle attachment member may be one piece and not detachable. Alternatively, the handle and the handle attachment member may be reversibly attached in a different manner than described above, including, but not limited to, latches or fasteners.

In a further embodiment, there is provided the above floor removal tool wherein the back of the second plate member is substantially flat. The flat back facilitates even force distribution and control of force direction when the plate is struck with another device or tool.

In yet another embodiment, there is provided the above floor removal tool that may further comprise a fulcrum sill, the fulcrum sill preventing rotational or pivotal movement of the floor removal tool about the axis where the thin plate member and second plate member connect, when a suitably sized block or the like is placed under the sill. Rotation around this higher axis helps limit the damage to the existing material on which the floor removal tool rests.

In a further embodiment, there is provided the above floor removal tool wherein the handle may comprise a crow bar, nail removal tool, or a combination thereof. However, it is envisioned that the nail removal tool may be used to remove other fasteners including, but not limited to, staples. In a preferred embodiment wherein the handle comprises crow bar, prying tool, nail removal tool or any other tool, the handle is detachable from the floor removal tool to facilitate unencumbered use thereof.

In yet another embodiment, there is provided the above floor removal tool wherein the angle formed by the plane of the first plate member and the handle is less than about 90 degrees. In a particular embodiment, the angle formed between the plane of the first plate member and the handle is 85 degrees, but is not limited to as such. Other angles are contemplated, for example, but not limited to 60, 65, 70. 75, 80, 85 or 90 degrees or any value therein between. It is also contemplated that the angle formed by the plane of the first plate member and the handle be more than 90 degrees, for example, 95, 100, 110, 115 or 120 degrees, or any value therein between. However, the angle is not limited to the values noted above or herein.

In another embodiment, there is provided the above floor removal tool wherein the handle facilitates rotational or pivotal movement of the thin plate member along its axis at the distal portion thereof where it connects with the second plate extending transversely therefrom. It is also contemplated that the handle may facilitate the lifting of the base member in a vertical or near vertical direction to aid in floor removal.

In one embodiment, the handle comprises a nail removal tool wherein the nail remover tool may comprise:
a lever (150), wherein the lever is angled approximately 45° from the handle member, the lever comprising a bevel or wedge (160), further comprising a fissure (170) in the center of the lever; and
a rounded member or fulcrum (180), comprising an aperture (190) on the side opposite the lever for optionally receiving a tool engaging member, the tool engaging member engaging a surface inside, around, or both inside and around the aperture in the rounded fulcrum.

In another embodiment, the handle comprises a nail removal tool wherein the nail remover tool may comprise:
a lever (150), wherein the lever is angled approximately 46° from the handle member, the lever comprising a bevel or wedge (160), further comprising a fissure (170) in the center of the bevel or wedge;
a fulcrum heel (210), wherein the fulcrum heel is angled 15° from the handle; and hook brackets that are an extension from the fulcrum heel and protrude beyond a third plate member, wherein the third plate member connects the fulcrum heel to the bevel or wedge on the side opposite the fissure; the third plate member comprising an aperture (190) for optionally receiving a tool engaging member, the tool engaging member engaging a surface inside, around, or both inside and around the aperture in the third plate member.

In another contemplated embodiment the lever of the nail removal tool may be situated at any angle with respect to the handle member or may not be angled at all. Furthermore, the fissure may be located in another position other than centered. It is further contemplated that the rounded fulcrum may not be present or may be replaced by a fulcrum sill similar to that contemplated for the floor removal tool. Similarly, it is envisioned that the fulcrum heel may be present at a different angle from the handle other than 15°, it may not be angled at all, or it may be replaced by a fulcrum sill similar to that contemplated for the floor removal tool.

In an embodiment of the present invention, the hook brackets may be used to remove material from a surface by hooking these brackets and pulling or leveraging the material away from the surface. It is also envisioned that there may be one or a plurality of hook brackets on the nail removal tool, or the brackets may be absent entirely.

In yet another embodiment, there is provided a use for the floor removal tool wherein the floor removal tool is for use to remove a substance adhered to a surface.

In a further embodiment, there is provided a use for the nail removal tool attached to the floor removal device wherein the nail removal tool is for use to remove a substance adhered to a surface.

In a further embodiment, there is provided a use for the floor removal tool or nail removal tool, wherein the substance removed is flooring. It is contemplated that these tools could remove various types of flooring such as, but not limited to, tile, hardwood, laminate, vinyl flooring or any combination thereof. Other types of material adhered to the floor are also contemplated.

In a further embodiment, there is provided a use for the floor removal tool or nail removal tool, wherein the substance removed is subflooring. The subflooring may include, but is not limited to, felt, rubber, foam, wood, or cork subfloors, vapour barrier underlay, fiber cement panels, separation membranes, and acoustic membranes.

In a further embodiment, there is provided a method of removing a material from a surface, which may comprise:
a. positioning the floor removal tool adjacent to the material to be removed,
b. striking the second plate member with an object, non-powered tool, a man powered tool, an electric tool, a gas powered tool, a pneumatic tool or any combination thereof to facilitate insertion of the floor removal tool under the material to be removed, and
c. pushing or pulling the handle in a direction that leverages the material away from the surface.

In positioning the floor removal tool, it may be possible to slide or place the tool under the flooring or subflooring before striking with a man-powered tool or the like to further insert said floor removal tool. It is further contemplated that the user may not be required to strike the second plate member to facilitate the insertion and removal of flooring or subflooring, and manually sliding it under said materials would suffice to leverage the required material.

In a further embodiment, there is provided the method above wherein the man-powered tool is a hammer or sledgehammer. It is also contemplated that the man-powered tool could be any tool capable of striking the second plate member with sufficient force, including, but not limited to, a mallet or crowbar.

In yet another embodiment, there is provided a method of removing a material from a surface, which may comprise:
a. positioning the floor removal tool adjacent to the material,
b. engaging the tool engaging member of the floor removal tool with a pneumatic tool,
c. activating the pneumatic tool to insert the floor removal tool under the material, and
d. pushing or pulling the handle in a direction that leverages the material away from the surface.

It is also contemplated that continuing to activate the pneumatic tool may suffice in removing the flooring or subflooring from a surface, without the need to pull on the handle to leverage the material away from the surface.

In a further embodiment, there is provided the method from above wherein the pneumatic tool is a jackhammer. It is also envisioned that the pneumatic tool may be, but is not limited to, an air hammer, a chipping hammer, or other air-powered device capable of facilitating the function of the floor removal tool. It is also contemplated that the tool used to engage the tool engaging member may be electric in nature and include those tools mentioned above, without being limiting.

In a further embodiment, there is provided a method of removing a material from a surface, which may comprise:
a. detaching the handle from the floor removal tool,
b. positioning the nail removal tool, under the material, and
c. pushing or pulling the handle in a direction that leverages the material away from the surface.

It is also envisioned that the handle does not need to be detached from the floor removal tool to perform its desired function.

In yet another embodiment, there is provided a method of removing a material from a surface, which may comprise:
a. detaching the handle from the floor removal tool,
b. positioning the nail removal tool adjacent to the material,
c. engaging the tool engaging member of the nail removal tool with a pneumatic tool,
d. activating the pneumatic tool to insert the nail removal tool under the material, and
e. pushing or pulling the handle in a direction that leverages the material away from the surface.

In a contemplated embodiment, the handle does not need to be detached from the floor removal tool to perform its desired function. Moreover, it is envisioned that the nail removal tool may be placed under the material in question before the pneumatic tool is engaged. It is further contemplated that continuously activating the pneumatic tool may negate the need to leverage the flooring or subflooring up via the handle.

In yet another embodiment, there is provided the above method, wherein the pneumatic tool is a jackhammer. It is also envisioned that the pneumatic tool may be, but is not limited to, an air hammer, a chipping hammer, or other air-powered device capable of facilitating the function of the nail removal tool. It is also contemplated that the tool used to engage the tool engaging member may be electric in nature and include those mentioned above, without being limiting.

In a further embodiment, there is provided a method of removing a material from a surface, comprising:
a. positioning the floor removal tool adjacent to the material,
b striking the second plate member with a man-powered tool to facilitate insertion of the floor removal tool under the material,
c. attaching a hook or jack or the like to the plurality of hook apertures, and
d. mechanically lifting the floor removal tool to remove the material.

In a further embodiment, there is provided a method of removing a material from a surface, comprising:
a. positioning the floor removal tool adjacent to the material,
b. striking the second plate member with a man-powered tool to facilitate insertion of the floor removal tool under the material,
c. attaching a hook or jack or the like to the plurality of fulcrum apertures, and
d. mechanically lifting the floor removal tool to remove the material.

It is also envisioned that a device or the like being attached to the hook apertures not be limited to a hook or jack, but any device or the like that could facilitate the lifting of the floor removal tool. The device used to lift the floor removal tool may be hand powered or electric, without being limiting.

In yet another embodiment, there is provided a floor removal tool wherein the plurality of bevels or wedges are spaced to fit around building materials. These plurality of bevels or wedges can be equally spaced or be variably spaced.

In a further embodiment, there is provided a floor removal tool wherein the building materials are wooden beams, metal beams, stone beams, plastic piping, or metal piping. It is contemplated that the structural materials are not limited to those mentioned above, but may be any structure wherein the floor removal tool would need to be placed around to facilitate the removal of flooring or subflooring.

In a further embodiment, there is provided a floor removal tool wherein the building materials are about 2 inches×4 inches, about 4 inches×4 inches, or about 4 inches in diameter or less. It is envisioned that the dimensions of the building materials described above are not limited to those described but could be any size beam, pipe, or conduit, typically found within buildings without being limiting. The building materials may also be irregular in size and need not be of a given diameter or dimension.

The present invention has been described with regard to one or more embodiments. However, it will be apparent to persons skilled in the art that a number of variations and modifications can be made without departing from the scope of the invention as defined in the claims.

1. A floor removal tool (10) comprising,
a base member (20) comprising a thin plate member (30), the thin plate member comprising a bevel or wedge (40) at a first proximal side (50), the opposite distal side (60) of the thin plate member mating with or integrally attached to a second plate or rectangular member (70) extending transversely upward therefrom,
a bracing member (80), the bracing member forming an integral attachment with both the thin plate member (30) at or near the distal side and the second plate member (70), at the point, upward from the point, or both at the point and upward from the point at which the thin plate member and second plate member intersect, and centered in respect thereof, the bracing member (80) forming a solid or hollow member or tube, the hollow member or tube comprising an aperture (90) on the reverse side of the second plate member, the aperture for optionally receiving a tool engaging member, the tool engaging member engaging a surface inside, around or both inside and around the aperture on the reverse of the second plate member;
a handle attachment member (100) attached or integral with the bracing member (80) and extending therefrom, the handle attachment member adapted to receive a handle (110) or a second tool member.

2. The floor removal tool of claim 1, further comprising a bend, lip, ledge, or fulcrum sill (120) that extends about perpendicularly from the second plate member opposite the side contacting the thin plate member.

3. The floor removal tool of claim 1, wherein the aperture on the reverse side of the second plate member receives a tool engaging member, a chisel, or pneumatic tool.

4. The floor removal tool of claim 1, wherein the aperture is surrounded by a mating assembly for receiving a tool engaging member, a chisel, or pneumatic tool.

5. The floor removal tool of claim 1, wherein the thin plate member comprises U-shaped structure or comprises a plurality of bevels or wedges at the proximal side.

6. The floor removal tool of claim 1, wherein the plurality of bevels or wedges at the proximal side of the thin plate member are separated by one or more slots (130).

7. The floor removal tool of claim 1, wherein the bevels or wedges are tapered along about a quarter or more of the length of the first plate member.

8. The floor removal tool of claim 1, wherein the tool is made of high carbon steel and the handle is made of hollow aerospace aluminum.

9. The floor removal tool of claim 2, wherein the bend, lip, ledge, or fulcrum sill comprises a plurality of fulcrum apertures (200) which facilitate application of upward force of the first plate member generally perpendicular to the plane thereof.

10. The floor removal tool of claim 1, wherein the handle engages the handle attachment member via spring-loaded members, one or more quick release pins, or is threadedly engaged via screw threads.

11. The floor removal tool of claim 1, wherein the back of the second plate is substantially flat.

12. The floor removal tool of claim 2, comprising a fulcrum sill, the fulcrum sill preventing rotational or pivotal movement of the floor removal tool about the axis where the thin plate and second plate connect, when a suitably sized block or the like is placed under the sill.

13. The floor removal tool of claim 10, wherein the handle comprises a crow bar, nail removal tool, or a combination thereof.

14. The floor removal tool of claim 1, wherein the angle formed by the plane of the first plate member and the handle is less than about 90 degrees.

15. The floor removal tool of claim 14, wherein the angle formed by the plane of the first plate member and the handle is about 85 degrees.

16. The floor removal tool of claim 1, wherein the handle facilitates rotational or pivotal movement of the thin plate member along its axis at the distal portion thereof where it connects with the second plate extending transversely therefrom.

17. The floor removal tool of claim 13, wherein the nail remover tool comprises:
a lever (140), wherein the lever is angled approximately 46° from the handle member, the lever comprising a bevel or wedge (150), further comprising a fissure (160) in the center of the bevel or wedge;
a fulcrum heel (210), wherein the fulcrum heel is angled 15° from the handle member; and
hook brackets that are an extension from the fulcrum heel and protrude beyond a third plate member, wherein the third plate member is connected to the fulcrum heel and the bevel or wedge on the side opposite the fissure, and wherein the third plate member comprises an aperture (190) for optionally receiving a tool engaging member, the tool engaging member engaging a surface inside, around, or both inside and around the aperture in the third plate member.

18-29. (canceled)

30. The floor removal tool of claim 6, wherein the plurality of bevels or wedges are spaced to fit around building materials, which may be wooden beams, metal beams, stone beams, plastic piping, or metal piping.

31. (canceled)

32. The floor removal tool of claim 30, wherein the building materials are 2 inches×4 inches, 4 inches×4 inches, or 4 inches in diameter or less.

33. A method of removing a material from a surface, which comprises positioning the floor removal tool of claim 1 adjacent to the material and using the floor removal tool to leverage the material away from the surface.
